(19) United States
(12) Patent Application Publication
(10) Pub. No.: US 2020/0255677 A1
(43) Pub. Date: Aug. 13, 2020

(54) RADIATION-CURABLE INK JET COMPOSITION AND RECORDING METHOD

(71) Applicant: Seiko Epson Corporation, Tokyo (JP)

(72) Inventors: Kyohei TANAKA, Matsumoto (JP); Midori SEKINE, Matsumoto (JP); Keitaro NAKANO, Matsumoto (JP)

(21) Appl. No.: 16/784,345

(22) Filed: Feb. 7, 2020

(30) Foreign Application Priority Data
Feb. 8, 2019 (JP) 2019-021509

(51) Int. Cl. C09D 11/101; C09D 11/107; C09D 11/30; B41M 5/00; B41J 11/00; B41M 5/52

(52) U.S. Cl. CPC C09D 11/101; C09D 11/107; B41M 5/5209; B41M 5/0023; B41J 11/002; C09D 11/30

(57) ABSTRACT

A radiation-curable ink jet composition contains polymerizable compounds including a monofunctional monomer and a multifunctional monomer. The amount of the monofunctional monomer is 90 mass % or more relative to the total amount of the polymerizable compounds. The weighted mean of glass transition temperatures of homopolymers of the polymerizable compounds with the content mass ratio of each of the polymerizable compounds taken as a weight is 42° C. or higher. The weighted means of SP values of the polymerizable compounds with the content mass ratio of each of the polymerizable compounds taken as a weight is from 9.5 to 10.0.

The present application is based on, and claims priority from JP Application Serial Number 2019-021509, filed Feb. 8, 2019, the disclosure of which is hereby incorporated by reference herein in its entirety.

### BACKGROUND

### 1. Technical Field

The present disclosure relates to a radiation-curable ink jet composition and a recording method.

### 2. Related Art

Ink jet recording methods enable recording of high-definition images with relatively simple apparatuses and are rapidly developing in various fields. During development, various studies about adhesion to substrates and the like have been carried out. For example, JP-A-2013-79383 discloses that a monofunctional monomer having an SP value of 8.5 or less and a monofunctional monomer having an SP value of 10.3 or more together form electrostatic bonding with polar groups on the substrate surface while the affinity to the substrate is maintained high, thus achieving strong adhesion.

However, studies carried out by the inventors of the present disclosure have revealed that the adhesion achieved by the method described in JP-A-2013-79383 is still insufficient.

### SUMMARY

According to an aspect of the present disclosure, a radiation-curable ink jet composition contains polymerizable compounds including a monofunctional monomer and a multifunctional monomer. The amount of the monofunctional monomer is 90 mass % or more relative to the total amount of the polymerizable compounds. The weighted mean of glass transition temperatures of homopolymers of the polymerizable compounds with the content mass ratio of each of the polymerizable compounds taken as a weight is 42° C. or higher. The weighted means of SP values of the polymerizable compounds with the content mass ratio of each of the polymerizable compounds taken as a weight is from 9.5 to 10.0.

In the radiation-curable ink jet composition, the weighted mean of glass transition temperatures may be 48° C. or higher.

In the radiation-curable ink jet composition, the amount of the multifunctional monomer may be 0.01 mass % or more and 10 mass % or less relative to the total amount of the polymerizable compounds.

In the radiation-curable ink jet composition, the multifunctional monomer may include a vinyl ether group-containing (meth)acrylic acid ester represented by formula (1):

CH₂═CR¹—COOR²—O—CH═CH—R³ . . . (1)

wherein R¹ is a hydrogen atom or a methyl group, R² is a divalent organic residue having 2 to 20 carbon atoms, and R³ is a hydrogen atom or a monovalent organic residue having 1 to 11 carbon atoms.

According to an aspect of the present disclosure, a recording method includes: a discharging step of discharging the radiation-curable ink jet composition from an ink jet head and attaching the radiation-curable ink jet composition to a recording medium; and an irradiating step of irradiating the ink jet composition attached to the recording medium with radiation.

According to an aspect of the present disclosure, a recorded article includes: a cured product of the radiation-curable ink jet composition; and a recording medium to which the cured product is attached.

### DESCRIPTION OF EXEMPLARY EMBODIMENTS

Embodiments of the present disclosure (hereinafter referred to as “embodiments”) will be described below in detail. However, the present disclosure is not limited to these embodiments, and various modifications can be made without departing from the spirit or scope of the present disclosure.

As used herein, the term “(meth)acryloyl” refers to at least one of an acryloyl and the corresponding methacryloyl, the term “(meth)acrylate” refers to at least one of an acrylate and the corresponding methacrylate, and the term “(meth)acrylic” refers to at least one of acrylic and the corresponding methacrylic.

### 1. Radiation-Curable Ink Jet Composition

A radiation-curable ink jet composition according to an embodiment (hereinafter also referred to simply as a “composition”) contains polymerizable compounds including a monofunctional monomer and a multifunctional monomer. The amount of the monofunctional monomer is 90 mass % or more relative to the total amount of the polymerizable compounds. The weighted mean of glass transition temperatures of homopolymers of the polymerizable compounds with the content mass ratio of each of the polymerizable compounds taken as a weight is 42° C. or higher. The weighted means of SP values of the polymerizable compounds with the content mass ratio of each of the polymerizable compounds taken as a weight is from 9.5 to 10.0.

In this embodiment, the flexibility and adhesion of a coating film can be improved by controlling the amount of the monofunctional monomer in a predetermined range. The rub fastness of the coating film can also be improved by controlling the properties of the polymerizable compounds such that the weighted mean of glass transition temperatures of homopolymers of the polymerizable compounds is in a predetermined range. Moreover, the adhesion of the coating film to a wide range of substrates can also be improved by controlling the weighted mean of SP values of the polymerizable compounds in the composition.

The radiation-curable ink jet composition according to this embodiment is used to be discharged from an ink jet head by the ink jet method. A radiation-curable ink composition will be described below as an embodiment of the radiation-curable ink jet composition. However, the composition according to this embodiment may be a composition other than an ink composition and may be, for example, a composition used for 3D molding.

The radiation-curable ink jet composition according to this embodiment is cured by irradiation with radiation. Examples of the radiation include ultraviolet radiation, infrared radiation, visible light, and X-rays. The radiation is preferably ultraviolet radiation because a radiation source is easily available and widely used, and materials suitable for curing by irradiation with ultraviolet radiation are easily available and widely used.

Possible components, physical properties, and a manufacture method for the radiation-curable ink jet composition according to this embodiment will be described below.

### 1.1. Polymerizable Compound

The polymerizable compounds include a monofunctional monomer having one polymerizable functional group and a multifunctional monomer having multiple polymerizable functional groups. As necessary, the polymerization compounds may include an oligomer having one or more polymerizable functional groups. Each polymerizable compound may be used alone or in combination of two or more.

In this embodiment, the weighted mean of the glass transition temperatures of homopolymers of the polymerizable compounds with the content mass ratio of each of the polymerizable compounds taken as a weight is 42° C. or higher, preferably 44° C. or higher, more preferably 46° C. or higher, and still more preferably 48° C. or higher. When the weighted mean of the glass transition temperatures is 42° C. or higher, the rub fastness of the coating film at room temperature can be improved. The upper limit of the weighted mean of the glass transition temperatures is preferably, but not necessarily, 60° C. or lower, more preferably 58° C. or lower, and still more preferably 55° C. or lower.

The method for calculating the weighted mean of glass transition temperatures will be described. The weighted mean of glass transition temperatures is represented by Tg_{All}, the glass transition temperature of the homopolymer of each of the polymerizable compounds is represented by Tg_{N}, and the content mass ratio of each of the polymerizable compounds is represented by X_{N} (mass %). N is a number in ascending order from 1 depending on the number of polymerizable compounds contained in the radiation-curable ink jet composition. For example, in the case of using three polymerizable compounds, Tg₁, Tg₂, and Tg₃ are generated. The glass transition temperature of the homopolymer of each of the polymerizable compounds is available from the safety data sheet (SDS) or catalog information for the polymerizable compounds. The weighted mean Tg_{All} of glass transition temperatures is the sum of the products of the content X_{N} and the glass transition temperature Tg_{N} calculated for the polymerizable compounds. The following formula (2) is thus satisfied.

Tg_{All}=ΣTg_{N}×X_{N} . . . (2)

In this embodiment, the weighted means of SP values of the polymerizable compounds with the content mass ratio of each of the polymerizable compounds taken as a weight is from 9.5 to 10.0. When the weighted mean of SP values is in the above range, the adhesion to recording media made of various materials can be improved. Studies performed by the inventors of the present disclosure reveal that the adhesion is low even when the composition contains a polymerizable compound having a high SP value and a polymerizable compound having a low SP value. Further studies performed by the inventors of the present disclosure reveal that it is necessary to control the weighted mean of SP values in a particular value range in order to improve the adhesion to recording media made of various materials.

The method for calculating the weighted mean of SP values will be described. The weighted mean of SP values is represented by SP_{A11}, the SP value of each of the polymerizable compounds is represented by SP_{N}, and the content mass ratio of each of the polymerizable compounds is represented by X_{N} (mass %). N is a number in ascending order from 1 depending on the number of polymerizable compounds contained in the radiation-curable ink jet composition. For example, in the case of using three polymerizable compounds, SP₁, SP₂, and SP₃ are generated. The SP value of each of the polymerizable compounds is available from the safety data sheet (SDS) or catalog information for the polymerizable compounds. The weighted mean SP_{All} of SP values is the sum of the products of the content X_{N} and the SP_{N} calculated for the polymerizable compounds. The following formula (3) is thus satisfied.

SP_{All}=ΣSP_{N}×X_{N} . . . (3)

The weighted mean of the glass transition temperatures and the weighted mean of the SP values can be controlled by the glass transition temperatures and SP values of the polymerizable compounds used and the content mass ratios of the polymerizable compounds used.

### 1.1.1. Monofunctional Monomer

Examples of the monofunctional monomer according to this embodiment include, but are not limited to, a monofunctional acrylate having a polycyclic hydrocarbon group, a nitrogen-containing monofunctional monomer, an aromatic group-containing monofunctional monomer, and a saturated aliphatic group-containing monofunctional monomer. As necessary, the monofunctional monomer according to this embodiment may further include other monofunctional monomers. Examples of other monofunctional monomers that can be used include, but are not limited to, known monofunctional monomers having polymerizable functional groups, particularly, polymerizable functional groups having an unsaturated carbon-carbon double bond.

The amount of the monofunctional monomer is 90 mass % or more, preferably 92 mass % or more, and more preferably 94 mass % or more relative to the total amount of the polymerizable compounds. When the amount of the monofunctional monomer is 90 mass % or more relative to the total amount of the polymerizable compounds, the flexibility and adhesion of the coating film are further improved. The upper limit of the amount of the monofunctional monomer is preferably, but not necessarily, 99 mass % or less, more preferably 98 mass % or less, and still more preferably 97 mass % or less, relative to the total amount of the polymerizable compounds. When the amount of the monofunctional monomer is 99 mass % or less relative to the total amount of the polymerizable compounds, the rub fastness tends to be further improved.

The amount of the monofunctional monomer is preferably 78 mass % or more, more preferably 80 mass % or more, and still more preferably 82 mass % or more, relative to the total amount of the composition. When the amount of the monofunctional monomer is 78 mass % or more relative to the total amount of the composition, the flexibility and adhesion of the coating film tend to be further improved. The upper limit of the amount of the monofunctional monomer is preferably 92 mass % or less, more preferably 90 mass % or less, and still more preferably 88 mass % or less, relative to the total amount of the composition. When the amount of the monofunctional monomer is 92 mass % or less relative to the total amount of the composition, the rub fastness tends to be further improved.

Examples of the monofunctional monomer are illustrated below, but the monofunctional monomer in this embodiment is not limited to the following monomers.

### 1.1.1.1. Monofunctional Acrylate Having Polycyclic Hydrocarbon Group

Examples of the monofunctional acrylate having a polycyclic hydrocarbon group include, but are not limited to, acrylates having an unsaturated polycyclic hydrocarbon group, such as dicyclopentenyl acrylate and dicyclopentenyl oxyethyl acrylate; and acrylates having a saturated polycyclic hydrocarbon group, such as dicyclopentanyl acrylate and isobornyl acrylate. Among these, an acrylate having an unsaturated polycyclic hydrocarbon group is preferably contained, and at least dicyclopentenyl acrylate is more preferably contained. The use of such a monofunctional acrylate having a polycyclic hydrocarbon group tends to further improve the rub fastness of the coating film.

The amount of the monofunctional acrylate having a polycyclic hydrocarbon group is preferably from 5 to 45 mass %, more preferably from 10 to 40 mass %, and still more preferably from 15 to 35 mass %, relative to the total amount of the polymerizable compounds. When the amount of the monofunctional acrylate having a polycyclic hydrocarbon group relative to the total amount of the polymerizable compounds is in the above range, the rub fastness of the coating film tends to be further improved.

The amount of the monofunctional acrylate having a polycyclic hydrocarbon group is preferably from 5 to 40 mass %, more preferably from 10 to 40 mass %, and still more preferably from 15 to 35 mass %, relative to the total amount of the composition. When the amount of the monofunctional acrylate having a polycyclic hydrocarbon group relative to the total amount of the composition is in the above range, the rub fastness of the coating film tends to be further improved.

### 1.1.1.2. Nitrogen-Containing Monofunctional Monomer

Examples of the nitrogen-containing monofunctional monomer include, but are not limited to, nitrogen-containing monofunctional vinyl monomers, such as N-vinylcaprolactam, N-vinylformamide, N-vinylcarbazole, N-vinylacetamide, and N-vinylpyrrolidone; nitrogen-containing monofunctional acrylate monomers, such as acryloylmorpholine; and nitrogen-containing monofunctional acrylamide monomers, such as (meth)acrylamides, such as N-hydroxymethyl (meth)acrylamide, diacetone acrylamide, N,N-dimethyl (meth)acrylamide, and dimethylaminoethyl acrylate benzyl chloride quaternary salt.

Among these, any one of nitrogen-containing monofunctional vinyl monomers or nitrogen-containing monofunctional acrylate monomers is preferably contained; monomers having a nitrogen-containing heterocyclic structure, such as N-vinylcaprolactam, N-vinylcarbazole, N-vinylpyrrolidone, or acryloylmorpholine, are more preferred; and either N-vinylcaprolactam or acryloylmorpholine is still more preferably contained.

The use of such a nitrogen-containing monofunctional monomer tends to further improve the rub fastness of the coating film. Moreover, a nitrogen-containing monofunctional vinyl monomer having a nitrogen-containing heterocyclic structure, such as n-vinylcaprolactam, tends to further improve the flexibility of the coating film, and a nitrogen-containing monofunctional acrylate monomer having a nitrogen-containing heterocyclic structure, such as acryloylmorpholine, tends to further reduce the odor of the composition.

The amount of the nitrogen-containing monofunctional monomer is preferably from 5 to 40 mass %, more preferably from 5 to 35 mass %, and still more preferably from 5 to 30 mass %, relative to the total amount of the polymerizable compounds. When the amount of the nitrogen-containing monofunctional monomer is 5 mass % or more relative to the total amount of the polymerizable compounds, the rub fastness of the coating film tends to be further improved. When the amount of the nitrogen-containing monofunctional monomer is 40 mass % or less relative to the total amount of the polymerizable compounds, the adhesion tends to be further improved.

The amount of the nitrogen-containing monofunctional monomer is preferably from 5 to 40 mass %, more preferably from 5 to 35 mass %, and more preferably from 5 to 30 mass %, relative to the total amount of the composition. When the amount of the nitrogen-containing monofunctional monomer is 5 mass % or more relative to the total amount of the composition, the rub fastness of the coating film tends to be further improved. When the amount of the nitrogen-containing monofunctional monomer is 40 mass % or less relative to the total amount of the composition, the adhesion tends to be further improved.

### 1.1.1.3. Aromatic Group-Containing Monofunctional Monomer

Examples of the aromatic group-containing monofunctional monomer include, but are not limited to, phenoxyethyl (meth) acrylate, benzyl (meth) acrylate, alkoxylated 2-phenoxyethyl (meth) acrylate, ethoxylated nonylphenyl (meth) acrylate, alkoxylated nonylphenyl (meth) acrylate, p-cumylphenol EO-modified (meth) acrylate, and 2-hydroxy-3-phenoxypropyl (meth)acrylate. Among these monomers, phenoxyethyl (meth)acrylate and benzyl (meth)acrylate are preferred, phenoxyethyl (meth)acrylate is more preferred, and phenoxyethyl acrylate (PEA) is still more preferred. The use of such an aromatic group-containing monofunctional monomer tends to further improve the solubility of the polymerization initiator and further improve the curability of the composition. In particular, in the case of using an acylphosphine oxide polymerization initiator or a thioxanthone polymerization initiator, the solubility of such a polymerization initiator tends to be improved. The use of phenoxyethyl (meth)acrylate tends to further reduce odor.

In this embodiment, aromatic group-containing monofunctional monomers are not polycyclic hydrocarbon group-containing compounds.

Examples of the aromatic group-containing monofunctional monomer in other expression include compounds represented by general formula (4) below and compounds represented by general formula (5) below.

CH₂═CR⁴—COOR⁵—Ar . . . (4)

CH₂═CR⁴—COO—Ar . . . (5)

In formulas (4) and (5) above, R⁴ is a hydrogen atom or a methyl group. In formula (4) above, Ar represents an aromatic ring skeleton and is a monovalent organic residue that has at least one aryl group and in which a carbon atom of the aryl group is bonded to the group represented by R⁵, and R⁵ is a divalent organic residue having 1 to 4 carbon atoms. In formula (5) above, Ar represents an aromatic ring skeleton and is a monovalent organic residue that has at least one aryl group and in which a carbon atom of the aryl group is bonded to —COO — in the formula.

In general formula (4) above, preferred examples of the group represented by R⁵ include an optionally substituted linear, branched, or cyclic alkylene group having 1 to 4 carbon atoms, and an optionally substituted alkylene group having 1 to 4 carbon atoms and having an oxygen atom of an ether bond and/or an ester bond in the structure. Among these groups, alkylene groups having 1 to 4 carbon atoms, such as an ethylene group, an n-propylene group, an isopropylene group, and a butylene group; and alkylene groups having 1 to 4 carbon atoms and having an oxygen atom of an ether bond in the structure, such as an oxyethylene group, an oxy-n-propylene group, an oxyisopropylene group, and an oxybutylene group, are preferably used. When the organic residue is an optionally substituted group, examples of the substituent include, but are not limited to, a carboxyl group, an alkoxy group, a hydroxyl group, and a halo group. When the substituent is a group containing a carbon atom, the carbon atom is counted as the number of carbon atoms of the organic residue.

In general formulas (4) and (5) above, examples of the at least one aryl group included in Ar (aryl) (aromatic ring skeleton) include, but are not limited to, phenyl groups and naphthyl groups. The number of aryl groups is 1 or more and preferably 1 or 2. The aryl group may have a substituent at a carbon atom other than the following carbon atoms among the carbon atoms of the aryl group: the carbon atom bonded to the organic residue represented by R⁵ in formula (4); the carbon atom bonded to —COO— in formula (5); and, when multiple aryl groups are present, the carbon atoms connecting the aryl groups. When the aryl group has a substituent, the number of substituents per aryl group is 1 or more and preferably 1 or 2. Examples of the substituent include, but are not limited to, linear, branched, or cyclic alkyl group, alkoxy group, carboxyl group, halo group, and hydroxyl group having 1 to 10 carbon atoms.

The amount of the aromatic group-containing monofunctional monomer is preferably from 30 to 55 mass %, more preferably from 35 to 50 mass %, and still more preferably from 40 to 45 mass %, relative to the total amount of the polymerizable compounds. When the amount of the aromatic group-containing monofunctional monomer relative to the total amount of the polymerizable compounds is in the above range, the rub fastness of the coating film tends to be further improved.

The amount of the aromatic group-containing monofunctional monomer is preferably from 20 to 50 mass %, more preferably from 25 to 45 mass %, and still more preferably from 30 to 40 mass %, relative to the total amount of the composition. When the amount of the aromatic group-containing monofunctional monomer relative to the total amount of the composition is in the above range, the rub fastness of the coating film tends to be further improved.

### 1.1.1.3. Saturated Aliphatic Group-Containing Monofunctional Monomer

Examples of other monofunctional monomers include saturated aliphatic group-containing monofunctional monomers. In this embodiment, saturated aliphatic group-containing monofunctional monomers are not polycyclic hydrocarbon group-containing compounds.

Examples of saturated aliphatic group-containing monofunctional monomers include, but are not limited to, alicyclic group-containing monofunctional monomers, such as tert-butylcyclohexanol acrylate (TBCHA) and 2-(meth)acrylic acid-1,4-dioxaspiro[4,5]dec-2-yl methyl; linear or branched aliphatic group-containing monofunctional monomers, such as isoamyl (meth)acrylate, stearyl (meth)acrylate, lauryl (meth)acrylate, octyl (meth)acrylate, decyl (meth)acrylate, isodecyl (meth)acrylate, isomyristyl (meth)acrylate, isostearyl (meth) acrylate, 2-hydroxybutyl (meth) acrylate, butoxyethyl (meth) acrylate, tetrahydrofurfuryl (meth)acrylate, 2-hydroxyethyl (meth)acrylate, 2-hydroxypropyl (meth)acrylate; and lactone-modified flexible (meth)acrylate. Among these, alicyclic group-containing monofunctional monomers are preferred. The use of such a saturated alicyclic group-containing monofunctional monomer tends to further improve the curability of the composition.

The amount of the saturated aliphatic group-containing monofunctional monomer is preferably from 1 to 17.5 mass %, more preferably from 3 to 15 mass %, and still more preferably from 5 to 12.5 mass %, relative to the total amount of the polymerizable compounds. When the amount of the saturated aliphatic group-containing monofunctional monomer is 1 mass % or more relative to the total amount of the polymerizable compounds, the flexibility and adhesion of the coating film tend to be further improved. When the amount of the saturated aliphatic group-containing monofunctional monomer is 17.5 mass % or less relative to the total amount of the polymerizable compounds, the rub fastness of the coating film tends to be further improved.

The amount of the saturated aliphatic group-containing monofunctional monomer is preferably from 1 to 15 mass %, more preferably from 3 to 12.5 mass %, and still more preferably from 5 to 10 mass %, relative to the total amount of the composition. When the amount of the saturated aliphatic group-containing monofunctional monomer is 1 mass % or more relative to the total amount of the composition, the flexibility and adhesion of the coating film tend to be further improved. When the amount of the saturated aliphatic group-containing monofunctional monomer is 15 mass % or less relative to the total amount of the composition, the rub fastness of the coating film tends to be further improved.

### 1.1.1.4. Others

Examples of other monofunctional monomers that may be used include, in addition to the foregoing monomers, unsaturated carboxylic acids, such as (meth)acrylic acid, itaconic acid, crotonic acid, isocrotonic acid, and maleic acid; salts of the unsaturated carboxylic acids; esters, urethanes, amides, and anhydrides of unsaturated carboxylic acids; acrylonitrile, styrene, various unsaturated polyesters, various unsaturated polyethers, various unsaturated polyamides, and various unsaturated urethanes.

### 1.1.2. Multifunctional Monomer

Examples of the multifunctional monomer according to this embodiment include vinyl ether group-containing (meth)acrylates, bifunctional (meth)acrylates, and tri- or higher-functional (meth) acrylates. The multifunctional monomer is not limited to the foregoing monomers.

The amount of the multifunctional monomer is preferably 0.01 mass % or more, more preferably 0.5 mass % or more, and still more preferably 1 mass % or more relative to the total amount of the polymerizable compounds. When the amount of the multifunctional monomer is 1 mass % or more relative to the total amount of the polymerizable compounds, the rub fastness tends to be further improved. The upper limit of the amount of the multifunctional monomer is preferably 10 mass % or less, more preferably 7.5 mass % or less, and still more preferably 6 mass % or less relative to the total amount of the polymerizable compounds. When the amount of the multifunctional monomer is 10 mass % or less relative to the total amount of the polymerizable compounds, the flexibility and adhesion of the coating film tend to be further improved.

The amount of the multifunctional monomer is preferably 0.3 mass % or more, more preferably 0.5 mass % or more, and still more preferably 1 mass % or more relative to the total amount of the composition. When the amount of the multifunctional monomer is 1 mass % or more relative to the total amount of the composition, the rub fastness tends to be further improved. The upper limit of the amount of the multifunctional monomer is preferably 10 mass % or less, more preferably 7.5 mass % or less, and still more preferably 5 mass % or less relative to the total amount of the composition. When the amount of the multifunctional monomer is 10 mass % or less relative to the total amount of the composition, the flexibility and adhesion of the coating film tend to be further improved.

Examples of the multifunctional monomer are illustrated below, but the multifunctional monomer in this embodiment is not limited to the following monomers.

### 1.1.2.1. Vinyl Ether Group-Containing (Meth)Acrylate

Examples of vinyl ether group-containing (meth)acrylates include, but are not limited to, compounds represented by formula (1) below. The presence of the vinyl ether group-containing (meth)acrylate tends to reduce the viscosity of the composition and further improve discharge stability. It is also possible to further improve the curability of the composition and further increase the recording speed as the curability is improved.

CH₂═CR¹—COOR²—O—CH═CH—R³ . . . (1)

wherein R¹ is a hydrogen atom or a methyl group, R² is a divalent organic residue having 2 to 20 carbon atoms, and R³ is a hydrogen atom or a monovalent organic residue having 1 to 11 carbon atoms.

Examples of the divalent organic residue having 2 to 20 carbon atoms and represented by R² in formula (1) above include an optionally substituted linear, branched, or cyclic alkylene group having 2 to 20 carbon atoms; an optionally substituted alkylene group having 2 to 20 carbon atoms and having an oxygen atom of an ether bond and/or an ester bond in the structure; and an optionally substituted divalent aromatic group having 6 to 11 carbon atoms. Among these groups, alkylene groups having 2 to 6 carbon atoms, such as an ethylene group, an n-propylene group, an isopropylene group, and a butylene group; and alkylene groups having 2 to 9 carbon atoms and having an oxygen atom of an ether bond in the structure, such as an oxyethylene group, an oxy-n-propylene group, an oxyisopropylene group, and an oxybutylene group, are preferred. To further reduce the viscosity of the composition and further improve the curability of the composition, a compound having a glycol ether chain where R² is an alkylene group having 2 to 9 carbon atoms and having an oxygen atom of an ether bond in the structure, such as an oxyethylene group, an oxy n-propylene group, an oxyisopropylene group, and an oxybutylene group, is more preferred.

The monovalent organic residue having 1 to 11 carbon atoms and represented by R³ in formula (1) above is preferably an optionally substituted linear, branched, or cyclic alkyl group having 1 to 10 carbon atoms, or an optionally substituted aromatic group having 6 to 11 carbon atoms. Among these, an alkyl group having 1 to 2 carbon atoms, such as a methyl group or an ethyl group, or an aromatic group having 6 to 8 carbon atoms, such as a phenyl group or a benzyl group, is preferably used.

When the above organic residues are each optionally substituted groups, the substituents are classified into groups containing a carbon atom and groups containing no carbon atom. First, when the substituent is a group containing a carbon atom, the carbon atom is counted as the number of carbon atoms of the organic residue. Examples of the group containing a carbon atom include, but are not limited to, a carboxyl group and an alkoxy group. Next, examples of the group containing no carbon atom include, but are not limited to, a hydroxyl group and a halo group.

Specific examples of the compound of formula (1) include, but are not limited to, 2-vinyloxyethyl (meth) acrylate, 3-vinyloxypropyl (meth) acrylate, 1-methyl-2-vinyloxyethyl (meth) acrylate, 2-vinyloxypropyl (meth) acrylate, 4-vinyloxybutyl (meth) acrylate, 1-methyl-3-vinyloxypropyl (meth) acrylate, 1-vinyloxymethyl propyl (meth) acrylate, 2-methyl-3-vinyloxypropyl (meth) acrylate, 1,1-dimethyl-2-vinyloxyethyl (meth) acrylate, 3-vinyloxybutyl (meth)acrylate, 1-methyl-2-vinyloxypropyl (meth)acrylate, 2-vinyloxybutyl (meth) acrylate, 4-vinyloxycyclohexyl (meth)acrylate, 6-vinyloxyhexyl (meth)acrylate, 4-vinyloxymethylcyclohexylmethyl (meth) acrylate, 3-vinyloxymethylcyclohexylmethyl (meth) acrylate, 2-vinyloxymethylcyclohexylmethyl (meth) acrylate, p-vinyloxymethylphenylmethyl (meth) acrylate, m-vinyloxymethylphenylmethyl (meth) acrylate, o-vinyloxymethylphenylmethyl (meth) acrylate, 2-(2-vinyloxyethoxy)ethyl methacrylate, 2-(2-vinyloxyethoxy)ethyl acrylate, 2-(vinyloxyisopropoxy)ethyl (meth)acrylate, 2-(vinyloxyethoxy) propyl (meth) acrylate, 2-(vinyloxyethoxy) isopropyl (meth) acrylate, 2-(vinyloxyisopropoxy) propyl (meth) acrylate, 2-(vinyloxyisopropoxy) isopropyl (meth) acrylate, 2-(vinyloxyethoxyethoxy) ethyl (meth) acrylate, 2-(vinyloxyethoxyisopropoxy) ethyl (meth) acrylate, 2-(vinyloxyisopropoxyethoxy) ethyl (meth) acrylate, 2-(vinyloxyisopropoxyisopropoxy)ethyl (meth)acrylate, 2-(vinyloxyethoxyethoxy)propyl (meth)acrylate, 2-(vinyloxyethoxyisopropoxy)propyl (meth)acrylate, 2-(vinyloxyisopropoxyethoxy)propyl (meth)acrylate, 2-(vinyloxyisopropoxyisopropoxy)propyl (meth)acrylate, 2-(vinyloxyethoxyethoxy) isopropyl (meth)acrylate, 2-(vinyloxyethoxyisopropoxy)isopropyl (meth)acrylate, 2-(vinyloxyisopropoxyethoxy)isopropyl (meth)acrylate, 2-(vinyloxyisopropoxyisopropoxy)isopropyl (meth) acrylate, 2-(vinyloxyethoxyethoxyethoxy)ethyl (meth) acrylate, 2-(vinyloxyethoxyethoxyethoxyethoxy)ethyl (meth) acrylate, 2-(isopropenoxyethoxy)ethyl (meth)acrylate, 2-(isopropenoxyethoxyethoxy)ethyl (meth)acrylate, 2-(isopropenoxyethoxyethoxyethoxy)ethyl (meth)acrylate, 2-(isopropenoxyethoxyethoxyethoxyethoxy)ethyl (meth) acrylate, polyethylene glycol monovinyl ether (meth)acrylate, and polypropylene glycol monovinyl ether (meth)acrylate. Among these specific examples, 2-(2-vinyloxyethoxy)ethyl acrylate is particularly preferred in order to easily make a balance between the curability and the viscosity of the composition. In this embodiment, 2-(2-vinyloxyethoxy)ethyl acrylate may also be referred to as VEEA.

The amount of the vinyl ether group-containing (meth)acrylate is preferably from 0.5 to 10 mass %, more preferably from 0.75 to 8 mass %, and still more preferably from 1 to 6 mass %, relative to the total amount of the polymerizable compounds. When the amount of the vinyl ether group-containing (meth)acrylate relative to the total amount of the polymerizable compounds is in the above range, the composition tends to have low viscosity and higher discharge stability.

The amount of the vinyl ether group-containing (meth)acrylate is preferably from 0.5 to 10 mass %, more preferably from 0.75 to 8 mass %, and still more preferably from 1 to 6 mass %, relative to the total amount of the composition. When the amount of the vinyl ether group-containing (meth)acrylate relative to the total amount of the composition is in the above range, the composition tends to have low viscosity and higher discharge stability.

### 1.1.2.2. Bifunctional (Meth)Acrylate

Examples of bifunctional (meth)acrylates include, but are not limited to, dipropylene glycol diacrylate (DPGDA), diethylene glycol di(meth)acrylate, triethylene glycol di(meth)acrylate, tetraethylene glycol di(meth)acrylate, polyethylene glycol di(meth)acrylate, dipropylene glycol dimethacrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, ethylene oxide (EO) adduct di(meth)acrylate of bisphenol A, propylene oxide (PO) adduct di(meth)acrylate of bisphenol A, hydroxypivalic acid neopentyl glycol di(meth)acrylate, and polytetramethylene glycol di(meth)acrylate.

### 1.1.2.3. Tri- or Higher-Functional (Meth)Acrylate

Examples of tri- or higher-functional (meth)acrylates include, but are not limited to, trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glycerol propoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate.

### 1.2.3. Oligomer

The oligomer according to this embodiment is a multimer, such as dimer or trimer, having a polymerizable compound as a constituent and is a compound having one or more polymerizable functional groups. The term “polymerizable compound” herein is not limited to the foregoing monofunctional monomers and the foregoing multifunctional monomers. In this embodiment, polymerizable compounds having a molecular weight of 1000 or more are defined as oligomers, and polymerizable compounds having a molecular weight of less than 1000 are defined as monomers.

Examples of the oligomer include, but are not limited to, urethane acrylate oligomers including urethane as a repeating structure, polyester acrylate oligomers including ester as a repeating structure, and epoxy acrylate oligomers including epoxy as a repeating structure.

Among these, urethane acrylate oligomers are preferred, aliphatic urethane acrylate oligomers and aromatic urethane acrylate oligomers are more preferred, and aliphatic urethane acrylate oligomers are still more preferred. Urethane acrylate oligomers are preferably tetra- or lower-functional urethane acrylate oligomers and more preferably bifunctional urethane acrylate oligomers.

The use of such an oligomer tends to further improve the storage stability of the composition and further improve rub fastness.

The amount of the oligomer is preferably from 0.5 to 10 mass %, more preferably from 1 to 7.5 mass %, and still more preferably from 1.5 to 5 mass %, relative to the total amount of the polymerizable compounds. When the amount of the oligomer relative to the total amount of the polymerizable compounds is in the above range, the composition tends to have higher storage stability, and the coating film tends to have higher rub fastness.

The amount of the oligomer is preferably from 0.5 to 10 mass %, more preferably from 1 to 7.5 mass %, and still more preferably from 1.5 to 5 mass %, relative to the total amount of the composition. When the amount of the oligomer relative to the total amount of the composition is in the above range, the composition tends to have higher storage stability, and the coating film tends to have higher rub fastness.

### 1.2. Polymerization Initiator

The radiation-curable ink jet composition according to this embodiment preferably contains a polymerization initiator that generates an active species upon irradiation with radiation. The polymerization initiator may be used alone or in combination of two or more.

Examples of the polymerization initiator include, but are not limited to, known polymerization initiators, such as acylphosphine oxide polymerization initiators, alkylphenone polymerization initiators, titanocene polymerization initiators, and thioxanthone polymerization initiators. Among these, acylphosphine oxide polymerization initiators are preferred. The use of these polymerization initiators tends to further improve the curability of the composition, especially the curability in the curing process with UV-LED light.

Examples of acylphosphine oxide polymerization initiators include, but are not limited to, 2,4,6-trimethylbenzoyl diphenylphosphine oxide, bis(2,4,6-trimethylbenzoyl)-phenylphosphine oxide, and bis-(2,6-dimethoxybenzoyl)-2,4,4-trimethylpentyl phosphine oxide.

Examples of commercial products of such acylphosphine oxide polymerization initiators include IRGACURE 819 (bis(2,4,6-trimethylbenzoyl)-phenylphosphine oxide), IRGACURE 1800 (a mixture of bis-(2,6-dimethoxybenzoyl)-2,4,4-trimethylpentylphosphine oxide and 1-hydroxy-cyclohexyl-phenyl ketone in a mass ratio of 25:75), and IRGACURE TPO (2,4,6-trimethylbenzoyl diphenylphosphine oxide) (these products are all available from BASF SE).

The amount of the polymerization initiator is preferably from 1 to 20 mass %, more preferably from 3 to 15 mass %, still more preferably from 5 to 10 mass %, and yet still more preferably from 7 to 9 mass %, relative to the total amount of the composition. When the amount of the polymerization initiator is in the above range, the curability of the composition and the solubility of the polymerization initiator tend to be further improved.

### 1.3. Other Additives

The radiation-curable ink jet composition according to this embodiment may further contain additives, such as a colorant, a dispersant, a polymerization inhibitor, a slip agent, and a photosensitizer, as necessary.

### 1.3.1. Colorant

The radiation-curable ink jet composition according to this embodiment may further contain a colorant. The radiation-curable ink jet composition according to this embodiment containing a colorant can be used as a colored radiation-curable ink jet composition. The colorant may be at least one of a pigment and a dye.

The total amount of the colorant is preferably from 1 to 20 mass %, more preferably from 2 to 15 mass %, and still more preferably from 2 to 10 mass %, relative to the total amount of the composition. The radiation-curable ink jet composition according to this embodiment may be a clear ink that does not contain a colorant or contains a colorant in an amount not intended for coloring (e.g., in an amount of 0.1 mass % or less).

### 1.3.1.1. Pigment

The use of a pigment as a colorant can improve the light resistance of the radiation-curable ink jet composition. The pigment may be either an inorganic pigment or an organic pigment. The pigment may be used alone or in combination of two or more.

Examples of inorganic pigments that can be used include carbon black (Colour Index (C.I.) Generic Name Pigment Black 7), such as furnace black, lamp black, acetylene black, and channel black; iron oxide; and titanium oxide.

Examples of organic pigments include azo pigments, such as insoluble azo pigments, condensed azo pigments, azo lakes, and chelate azo pigments; polycyclic pigments, such as phthalocyanine pigments, perylene and perinone pigments, anthraquinone pigments, quinacridone pigments, dioxane pigments, thioindigo pigments, isoindolinone pigments, and quinophthalone pigments; dye chelates (e.g., basic dye chelates and acid dye chelates); dye lakes (basic dye lakes and acid dye lakes); nitro pigments, nitroso pigments, aniline black, and daylight fluorescent pigments.

Specific examples of carbon black used for black include No. 2300, No. 900, MCF 88, No. 33, No. 40, No. 45, No. 52, MA 7, MA 8, MA 100, No. 2200B, and the like (these products are available from Mitsubishi Chemical Corporation); Raven 5750, Raven 5250, Raven 5000, Raven 3500, Raven 1255, Raven 700, and the like (these products are available from Carbon Columbia); Regal 400R, Regal 330R, Regal 660R, Mogul L, Monarch 700, Monarch 800, Monarch 880, Monarch 900, Monarch 1000, Monarch 1100, Monarch 1300, Monarch 1400, and the like (available from Cabot Japan K.K.); and Color Black FW1, Color Black FW2, Color Black FW2V, Color Black FW18, Color Black FW200, Color Black 5150, Color Black 5160, Color Black S170, Printex 35, Printex U, Printex V, Printex 140U, Special Black 6, Special Black 5, Special Black 4A, and Special Black 4 (these products are available from Degussa AG).

Examples of pigments used for white include C.I. Pigment White 6, 18, and 21.

Examples of pigments used for yellow include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 155, 167, 172, and 180.

Examples of pigments used for magenta include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245, and C.I. Pigment Violet 19, 23, 32, 33, 36, 38, 43, and 50.

Examples of pigments used for cyan include C.I. Pigment Blue 1, 2, 3, 15, 15:1, 15:2, 15:3, 15:34, 15:4, 16, 18, 22, 25, 60, 65, and 66, and C.I. Vat Blue 4 and 60.

Examples of pigments other than pigments for magenta, cyan, and yellow include C.I. Pigment Green 7 and 10, C.I. Pigment Brown 3, 5, 25, and 26, and C.I. Pigment Orange 1, 2, 5, 7, 13, 14, 15, 16, 24, 34, 36, 38, 40, 43, and 63.

The amount of the pigment is preferably from 1 to 20 mass %, more preferably from 2 to 15 mass %, and still more preferably from 2 to 10 mass %, relative to the total amount of the composition.

### 1.3.1.2. Dye

The colorant may be a dye. Examples of the dye that can be used include, but are not limited to, acid dyes, direct dyes, reactive dyes, and basic dyes. The dye may be used alone or in combination of two or more.

Examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C.I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35.

### 1.3.2. Dispersant

When the radiation-curable ink jet composition contains a pigment, the composition may further contain a dispersant in order to improve pigment dispersibility. The dispersant may be used alone or in combination of two or more.

Examples of the dispersant include, but are not limited to, dispersants commonly used for preparing a pigment dispersion, such as a polymer dispersant. Specific examples include dispersants containing, as a main component, one or more selected from polyoxyalkylene polyalkylene polyamines, vinyl polymers and copolymers, acrylic polymers and copolymers, polyesters, polyamides, polyimides, polyurethanes, amino polymers, silicon-containing polymers, sulfur-containing polymers, fluorine-containing polymers, and epoxy resins.

Examples of commercial products of polymer dispersants include AJISPER series available from Ajinomoto Fine-Techno Co., Inc., Solsperse series (e.g., Solsperse 36000) available from Avecia, Inc. or Noveon, Inc., DISPERBYK series available from BYK Additives & Instruments, and DISPARLON series available from Kusumoto Chemicals, Ltd.

The amount of the dispersant is preferably from 0.1 to 2 mass %, more preferably from 0.1 to 1 mass %, and still more preferably from 0.1 to 0.5 mass %, relative to the total amount of the composition.

### 1.3.3. Polymerization Inhibitor

The radiation-curable ink jet composition according to this embodiment may further contain a polymerization inhibitor. The polymerization inhibitor may be used alone or in combination of two or more.

Examples of the polymerization inhibitor include, but are not limited to, p-methoxyphenol, hydroquinone monomethyl ether (MEHQ), 4-hydroxy-2,2,6,6-tetramethylpiperidin-N-oxyl, hydroquinone, cresol, t-butylcatechol, 3,5-di-t-butyl-4-hydroxytoluene, 2,2′-methylenebis(4-methyl-6-t-butylphenol), 2,2′-methylenebis(4-ethyl-6-butylphenol), 4,4′-thiobis(3-methyl-6-t-butylphenol), and hindered amine compounds.

The amount of the polymerization inhibitor is preferably from 0.05 to 1 mass %, more preferably from 0.05 to 0.5 mass %, relative to the total amount of the composition.

### 1.3.4. Slip Agent

The radiation-curable ink jet composition according to this embodiment may further contain a slip agent. The slip agent may be used alone or in combination of two or more.

The slip agent is preferably a silicone surfactant, and more preferably a polyester-modified silicone or a polyether-modified silicone. Examples of the polyether-modified silicone include BYK-378, BYK-3455, BYK-UV 3500, BYK-UV 3510, and BYK-UV 3530 (these products are available from BYK Additives & Instruments). Examples of the polyester-modified silicone include BYK-3570 (available from BYK Additives & Instruments).

The amount of the slip agent is preferably from 0.01 to 2 mass %, and more preferably from 0.05 to 1 mass %, relative to the total amount of the composition.

### 1.3.5. Photosensitizer

The radiation-curable ink jet composition according to this embodiment may further contain a photosensitizer. Examples of the photosensitizer include amine compounds (e.g., aliphatic amines, aromatic group-containing amines, piperidine, reaction products between epoxy resins and amines, and triethanolamine triacrylate), urea compounds (e.g., allyl thiourea and o-tolylthiourea), sulfur compounds (e.g., sodium diethyl dithiophosphate, soluble salts of aromatic sulfinic acids), nitrile compounds (e.g., N,N-diethyl-p-aminobenzonitrile), phosphorus compounds (e.g., tri-n-butylphosphine and sodium diethyldithiophosphide), nitrogen compounds (e.g., Michler's ketone, N-nitrosohydroxylamine derivatives, oxazolidine compounds, tetrahydro-1,3-oxazine compound, and a condensate of diamine and formaldehyde or acetaldehyde), and chlorine compounds (e.g., carbon tetrachloride and hexachloroethane).

### 1.4. Physical Properties

The viscosity of the radiation-curable ink jet composition according to this embodiment at 20° C. is preferably 25 mPa·s or less, and more preferably from 5 mPa·s to 25 mPa·s. When the viscosity of the composition at 20° C. is in the above range, a suitable amount of the composition is discharged from the nozzle, and the curved flight and scattering of the composition can be further reduced. As a result, the composition can be suitably used in an ink jet recording apparatus. The viscosity can be measured using a rheometer MCR-300 manufactured by Anton Paar by increasing the shear rate from 10 to 1000 under a 20° C. environment and reading the viscosity at a shear rate of 200.

The surface tension of the radiation-curable ink jet composition according to this embodiment at 20° C. is preferably 20 mN/m or more and 40 mN/m or less. When the surface tension of the radiation-curable ink jet composition at 20° C. is in this range, the composition is unlikely to wet the liquid-repellent nozzle surface. With this feature, a suitable amount of the composition is properly discharged from the nozzle, and the curved flight and scattering of the composition can be further reduced. As a result, the composition can be suitably used in an ink jet recording apparatus. The surface tension can be measured using an automatic surface tensiometer CBVP-Z (available from Kyowa Interface Science, Inc.) by determining the surface tension when the radiation-curable ink jet composition wets a platinum plate under a 20° C. environment.

### 1.5. Method for Manufacturing Composition

The radiation-curable ink jet composition is manufactured (prepared) by mixing components to be contained in the composition and stirring the mixture so as to sufficiently uniformly mix the components. In this embodiment, the process for preparing the radiation-curable ink jet composition preferably includes a step of subjecting a mixture of the polymerization initiator and at least part of monomers to at least one of an ultrasonic treatment and a heat treatment. This step can reduce the amount of oxygen dissolved in the prepared composition and enables the radiation-curable ink jet composition to have high discharge stability and high storage stability. The mixture contains at least the above components. The mixture may further contain other components to be contained in the radiation-curable ink jet composition or may contain all components to be contained in the radiation-curable ink jet composition. The mixture contains at least part of monomers to be contained in the radiation-curable ink jet composition.

### 2. Ink jet Recording Method

An ink jet recording method according to an embodiment includes: a discharging step of discharging the radiation-curable ink jet composition from an ink jet head and attaching the radiation-curable ink jet composition to a recording medium; and an irradiating step of irradiating the radiation-curable ink jet composition attached to the recording medium with radiation. This method can form a coating film in a region of the recording medium to which the radiation-curable ink jet composition is applied. Each step will be described below in detail.

### 2.1. Discharging Step

The discharging step involves discharging the heated composition from an ink jet head and attaching the composition to a recording medium. More specifically, the composition placed in a pressure-generating chamber of the ink jet head is discharged from nozzles by driving a pressure-generating unit. Such a discharging method is also referred to as an ink jet method.

Examples of an ink jet head used in the discharging step include a line head for recording with a line system, and a serial head for recording with a serial system.

In the line system using a line head, for example, an ink jet head having a width equal to or more than the recoding width of a recording medium is fixed to a recording apparatus. The recording medium is then moved in the sub-scanning direction (the longitudinal direction or transport direction of the recording medium), and ink droplets are discharged from the nozzles of the ink jet head in conjunction with this movement. An image is recorded on the recording medium accordingly.

In the serial system using a serial head, for example, an ink jet head is carried by a carriage movable in the width direction of a recording medium. The carriage is then moved in the main-scanning direction (the transverse direction or width direction of the recording medium), and ink droplets are discharged from nozzle orifices of the head in conjunction with this movement. An image can be recorded on the recording medium accordingly.

### 2.2. Irradiating Step

The irradiating step involves irradiating, with radiation, the radiation-curable ink jet composition attached to the recording medium. Upon irradiation with radiation, the monomer polymerization reaction starts, and the composition is cured to form a coating film. When a polymerization initiator is present at this time, the polymerization initiator generates an active species (initiation species), such as radical, acid, or base, and the monomer polymerization reaction is promoted by the function of the initiation species. When a photosensitizer is present, the photosensitizer absorbs radiation into an excited state, and the excited photosensitizer comes into contact with the polymerization initiator to promote the decomposition of the polymerization initiator, thus further achieving the curing reaction.

Examples of the radiation include ultraviolet radiation, infrared radiation, visible light, and X-rays. The composition is irradiated with radiation by using a radiation source disposed downstream of the ink jet head. Examples of the radiation source include, but are not limited to, UV-LEDs. The use of such a radiation source can downsize the apparatus and reduce costs. An UV-LED serving as an ultraviolet source is compact and thus can be installed into an ink jet recording apparatus.

For example, the radiation source can be installed into the carriage (both ends in the medium width direction, and/or medium transport direction side) carrying the ink jet head which discharges the radiation-curable ink jet composition. Moreover, high-speed curing at low energy can be achieved by the above components of the radiation-curable ink jet composition. The irradiation energy is calculated by multiplying irradiation time by irradiance. Therefore, the irradiation time can be shortened, which increases the printing speed. The irradiance can also be reduced. This can reduce a rise in temperature of prints and reduce the odor of the cured film.

### 3. Recorded Article

A recorded article according to an embodiment is obtained by attaching the radiation-curable ink jet composition to a recording medium and curing the radiation-curable ink jet composition. The composition having high flexibility and high adhesion can prevent cracking and chipping of a coating film in post-processing such as cutting or bending. The recorded article according to this embodiment can thus be preferably used for sign applications.

Examples of the material of the recording medium include, but are not limited to, plastics, such as polyvinyl chloride, polyethylene terephthalate, polypropylene, polyethylene, polycarbonate, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, polyvinyl acetal; surface-treated products of these plastics; glass, paper, metal, and wood.

Among these, polyvinyl chloride, which has an SP value of from 9.5 to 9.7, polyethylene terephthalate, which has an SP value of 12, polypropylene, which has an SP value of 8.0, and polyethylene, which has an SP value of 7.9, are preferred. When such recording media having an SP value of about 9.5 to about 10 are used, the advantageous effects of the composition according to this embodiment are particularly easily exerted to improve the adhesion of the coating film and effectively reduce cracking and chipping of the coating film in post-processing. When the SP value of the composition is in a limited range from 7 to 13, the coating film has high rub fastness and high adhesion to various recording media having an SP value in the range from 7 to 13.

The form of the recording medium is not limited either. Examples of the form include films, boards, and fabrics.

### EXAMPLES

The present disclosure will be described below in more detail by way of Examples. The present disclosure is not limited by Examples below.

### 1. Preparation of Ink Jet Composition

First, a colorant, a dispersant, and part of each monomer were weighed and placed in a pigment dispersion tank, and ceramic beads having a diameter of 1 mm were placed in the tank. The mixture was stirred to form a pigment dispersion in which the colorant was dispersed in the monomers. Next, the remaining monomers, a polymerization initiator, and a polymerization inhibitor were placed in a mixture tank, which was a stainless steel container, so as to obtain the composition described in Table 1. The mixture was mixed and stirred to complete dissolution. Subsequently, the pigment dispersion formed as described above was placed in the mixture tank, and the mixture was further mixed and stirred at normal temperature for 1 hour and then filtered through a 5 μm membrane filter to obtain a radiation-curable ink jet composition in Example. The value for each component shown in Examples in Table is on a mass % basis.

TABLE 1

| | | | Tg | SP | Example | | | | | | | Comparative Example | | | |
|---|---|---|---|---|---|---|---|---|---|---|---|---|---|---|---|
| | | | (° C.) | value | 1 | 2 | 3 | 4 | 5 | 6 | 7 | 1 | 2 | 3 | 4 |
| Composition | Monofunctional | PEA | −22 | 9.99 | 36.2 | 38.2 | 38.4 | 36.7 | 38.2 | 36.0 | 35.2 | 40.2 | 35.7 | 42.0 | 33.2 |
| (mass%) | monomer | NVC | 90 | 10.65 | 25.0 | 0.0 | 0.0 | 0.0 | 0.0 | 0.0 | 10.0 | 0.0 | 0.0 | 0.0 | 10.0 |
| | | ACMO | 145 | 11.55 | 8.0 | 14.0 | 11.0 | 0.0 | 12.0 | 12.0 | 12.0 | 17.0 | 0.0 | 15.0 | 15.0 |
| | | IBXA | 94 | 7.24 | 8.0 | 22.0 | 14.8 | 0.0 | 24.0 | 23.0 | 12.0 | 15.0 | 28.0 | 0.0 | 5.0 |
| | | DCPA | 110 | 10.53 | 0.0 | 10.0 | 10.0 | 36.7 | 8.0 | 7.6 | 8.0 | 0.0 | 14.0 | 25.2 | 0.0 |
| | | TBCHA | 38 | 7.78 | 7.0 | 0.0 | 10.0 | 8.8 | 0.0 | 0.0 | 5.0 | 10.0 | 4.5 | 0.0 | 10.0 |
| | Multifunctional | VEEA | 39 | 9.41 | 1.0 | 1.0 | 1.0 | 3.0 | 3.0 | 5.0 | 3.0 | 3.0 | 3.0 | 3.0 | 12.0 |
| | monomer | | | | | | | | | | | | | | |
| | Oligomer | CN991 | 27 | 11.57 | 2.0 | 2.0 | 2.0 | 2.0 | 2.0 | 3.6 | 2.0 | 2.0 | 2.0 | 2.0 | 2.0 |
| | Polymerization | Irg.819 | — | — | 4.0 | 4.0 | 4.0 | 4.0 | 4.0 | 4.0 | 4.0 | 4.0 | 4.0 | 4.0 | 4.0 |
| | initiator | TPO | — | — | 4.0 | 4.0 | 4.0 | 4.0 | 4.0 | 4.0 | 4.0 | 4.0 | 4.0 | 4.0 | 4.0 |
| | Polymerization | MEHQ | — | — | 0.1 | 0.1 | 0.1 | 0.1 | 0.1 | 0.1 | 0.1 | 0.1 | 0.1 | 0.1 | 0.1 |
| | inhibitor | | | | | | | | | | | | | | |
| | Slip agent | BYK-UN3500 | — | — | 0.5 | 0.5 | 0.5 | 0.5 | 0.5 | 0.5 | 0.5 | 0.5 | 0.5 | 0.5 | 0.5 |
| | Pigment | Carbon black | — | — | 4.0 | 4.0 | 4.0 | 4.0 | 4.0 | 4.0 | 4.0 | 4.0 | 4.0 | 4.0 | 4.0 |
| | Dispersant | solsperse 36000 | — | — | 0.2 | 0.2 | 0.2 | 0.2 | 0.2 | 0.2 | 0.2 | 0.2 | 0.2 | 0.2 | 0.2 |

| | | | | | | | | | | | | | | |
|---|---|---|---|---|---|---|---|---|---|---|---|---|---|---|
| Physical | Proportion (mass %) of | — | — | 96.6 | 96.6 | 96.6 | 94.3 | 94.3 | 90.1 | 94.3 | 94.3 | 94.3 | 94.3 | 83.9 |
| properties | monofunctional monomers in | | | | | | | | | | | | | |
| | polymerizable compounds | | | | | | | | | | | | | |
| | Weighted mean (° C.) of glass | — | — | 42.7 | 51.0 | 42.6 | 42.8 | 48.2 | 48.6 | 48.6 | 40.6 | 42.8 | 48.1 | 42.6 |
| | transition temperatures | | | | | | | | | | | | | |
| | Weighted mean of SP values | — | — | 9.9 | 9.6 | 9.6 | 10.0 | 9.5 | 9.6 | 9.8 | 9.6 | 9.1 | 10.4 | 9.9 |
| Evaluation | PP adhesion | — | — | A | A | A | A | A | A | A | A | A | D | D |
| items | PET adhesion | — | — | A | A | A | A | A | A | A | A | D | A | D |
| | Rub fastness | — | — | B | A | B | B | A | A | A | C | B | A | A |
| | Flexibility | — | — | A | A | A | A | A | A | A | A | A | A | D |

The abbreviations and the components of products used in Table 1 are as described below.

Monofunctional Monomer
PEA (trade name “Viscoat #192” available from Osaka Organic Chemical Industry Ltd., phenoxyethyl acrylate)
NVC (available from ISP Japan, Ltd., N-vinylcaprolactam)
ACMO (available from KJ Chemicals Corporation, acryloylmorpholine)
IBXA (available from Osaka Organic Chemical Industry Ltd., isobornyl acrylate)
DCPA (available from Hitachi Chemical Co., Ltd., dicyclopentenyl acrylate)
TBCHA (trade name “SR217”, available from Sartomer Company, Inc., tert-butylcyclohexanol acrylate)

### Multifunctional Monomer

VEEA (available from Nippon Shokubai Co., Ltd., 2-(2-vinyloxyethoxy) ethyl acrylate)

### Oligomer

CN991 (available from Sartomer, bifunctional urethane acrylate oligomer)

### Polymerization Initiator

Irg. 819 (trade name “IRGACURE 819” available from BASF SE, bis(2,4,6-trimethylbenzoyl)-phenylphosphine oxide)
TPO (trade name “IRGACURE TPO” available from BASF SE, 2,4,6-trimethylbenzoyl diphenylphosphine oxide)

### Polymerization Inhibitor

MEHQ (trade name “p-methoxyphenol” available from Kanto Chemical Co., Inc., hydroquinone monomethyl ether)

### Slip Agent

BYK-UV 3500 (available from BYK Additives & Instruments, acryloyl group-containing polyether-modified polydimethylsiloxane)

### Colorant (Pigment)

Carbon black (trade name “MA-100” available from Mitsubishi Chemical Corporation)

### Dispersant

Solsperse 36000 (available from The Lubrizol Corporation, polymer dispersant)

### 2. Evaluation Method

### 2.1. Evaluation of Flexibility

Each radiation-curable ink jet composition was applied to a PVC film (JT 5829 R available from Mactac) by using a bar coater such that the thickness of the composition was 10 μm. Next, the composition was cured by using a metal halide lamp (available from Eye Graphics Co., Ltd.) at an energy of 400 mJ/cm² to form a coating film. The release paper of the PVC film on which the coating film was formed was released and cut into a strip shape having a width of 1 cm and a length of 8 cm to prepare test pieces. The flexibility and elongation of each test piece were measured by using a tensile tester (TENSILON available from ORIENTEC Co., LTD). The elongation was the value at the time when the test piece was cracked when pulled at 5 mm/min. The value was calculated from {(length at cracking−length before stretching)/length before stretching×100}. The evaluation criteria are as described below.

### Evaluation Criteria

A: 300% or more
B: 250% or more and less than 300%
C: 200% or more and less than 250%
D: Less than 200%

### 2.2. Evaluation of PP Adhesion

Each radiation-curable ink jet composition was applied to a polypropylene board (available from Coroplast, Inc.) by using a bar coater such that the thickness of the composition was 10 μm. Next, the composition was cured by using a metal halide lamp (available from Eye Graphics Co., Ltd.) at an energy of 400 mJ/cm² to form a coating film. The obtained coating film was evaluated in the cross-cut test in accordance with JIS K5600-5-6.

More specifically, a 10×10 grid pattern was formed by making cross-cuts at intervals of 1 mm using a cutter with the blade of the cutting tool placed on the coating film at right angles. A transparent adhesive tape (25 mm wide) having a length of about 75 mm was attached to the grid, and the tape was rubbed with a finger sufficiently so as to allow the cured film to be seen through the tape. Next, the tape was assuredly released from the cured film at an angle near 60° in 0.5 to 1.0 seconds within 5 minutes after the tape was attached, and the grid condition was visually observed. The evaluation criteria are as described below.

### Evaluation Criteria

A: No peeling of the cured film was observed in the grid.

B: Peeling of the cured film was observed in less than 10% of the grid.

C: Peeling of the cured film was observed in 10% or more and less than 50% of the grid.

D: Peeling of the cured film was observed in 50% or more of the grid.

### 2.3. Evaluation of PET Adhesion

The adhesion to a polyethylene terephthalate film was evaluated in the same manner except that a polyethylene terephthalate film (available from Toray Industries, Inc.) was used as a recording medium instead of a polypropylene board (available from Coroplast, Inc.).

### Evaluation Criteria

A: No peeling of the cured film was observed in the grid.

B: Peeling of the cured film was observed in less than 10% of the grid.

C: Peeling of the cured film was observed in 10% or more and less than 50% of the grid.

D: Peeling of the cured film was observed in 50% or more of the grid.

### 2.4. Evaluation of Rub Fastness

The cured coating film obtained in the evaluation of flexibility was evaluated in the micro-scratch test in accordance with JIS R3255. The withstand load indicating rub fastness was measured by using a nano-layer scratch tester (CSR-5000 available from Nanotec Corporation). The withstand load was the load under which the stylus reached the medium surface in creating micro-scratches under load. The measurement was performed under the conditions: stylus diameter 15 μm, amplitude 100 μm, and scratch speed 10 μm/sec. The evaluation criteria are as described below.

### Evaluation Criteria

A: 30 mN/cm² or more

B: 25 mN/cm² or more and less than 30 mN/cm²

C: 20 mN/cm² or more and less than 25 mN/cm²

D: Less than 20 mN/cm²

### 3. Evaluation Results

Table 1 shows the components of the radiation-curable ink jet compositions used in Examples and the evaluation results. As shown in Table 1, the flexibility, adhesion, and rub fastness are good and all rated B or higher for the radiation-curable ink jet compositions of Example 1 to Example 7 in which the amount of monofunctional monomers is 90 mass % or more relative to the total amount of polymerizable compounds, the weighted mean of glass transition temperatures of homopolymers of the polymerizable compounds with the content mass ratio of each of the polymerizable compounds taken as a weight is 42° C. or higher, and the weighted means of SP values of the polymerizable compounds with the content mass ratio of each of the polymerizable compounds taken as a weight is from 9.5 to 10.0.

Specifically, as Examples are compared with Comparative Example 1, the rub fastness is found to be further improved when the weighted mean of glass transition temperatures of homopolymers of the polymerizable compounds is 42° C. or higher. As Examples are compared with Comparative Examples 2 and 3, the adhesion is found to be improved when the weighted mean of SP values of the polymerizable compounds with the content mass ratio of each of the polymerizable compounds taken as a weight is in the range from 9.5 to 10.0. As Examples are compared with Comparative Example 4, the flexibility and adhesion are found to be improved when the proportion of monofunctional monomers in the total polymerizable compounds is 90 mass % or more.

What is claimed is:

1. A radiation-curable ink jet composition comprising:
polymerizable compounds including a monofunctional monomer and a multifunctional monomer, wherein
an amount of the monofunctional monomer is 90 mass % or more relative to a total amount of the polymerizable compounds,
a weighted mean of glass transition temperatures of homopolymers of the polymerizable compounds with a content mass ratio of each of the polymerizable compounds taken as a weight is 42° C. or higher, and
a weighted means of SP values of the polymerizable compounds with the content mass ratio of each of the polymerizable compounds taken as a weight is from 9.5 to 10.0.

2. The radiation-curable ink jet composition according to claim 1, wherein the weighted mean of glass transition temperatures is 48° C. or higher.

3. The radiation-curable ink jet composition according to claim 1, wherein an amount of the multifunctional monomer is 0.01 mass % or more and 10 mass % or less relative to the total amount of the polymerizable compounds.

4. The radiation-curable ink jet composition according to claim 1, wherein the multifunctional monomer includes a vinyl ether group-containing (meth)acrylic acid ester represented by formula (1):
CH₂═CR¹—COOR²—O—CH═CH—R³ . . . (1)
wherein R¹ is a hydrogen atom or a methyl group, R² is a divalent organic residue having 2 to 20 carbon atoms, and R³ is a hydrogen atom or a monovalent organic residue having 1 to 11 carbon atoms.

5. A recording method comprising:
a discharging step of discharging the radiation-curable ink jet composition according to claim 1 from an ink jet head and attaching the radiation-curable ink jet composition to a recording medium; and
an irradiating step of irradiating the ink jet composition attached to the recording medium with radiation.

6. A recorded article comprising:
a cured product of the radiation-curable ink jet composition according to claim 1; and
a recording medium to which the cured product is attached.
